(19) United States
(12) Patent Application Publication
(10) Pub. No.: US 2014/0333762 A1
(43) Pub. Date: Nov. 13, 2014

(54) IMAGE MEASURING APPARATUS AND IMAGE MEASURING PROGRAM

(71) Applicant: MITUTOYO CORPORATION, Kanagawa (JP)

(72) Inventors: Hiroyuki YOSHIDA, Hiroshima (JP); Masafumi YAMANAKA, Hiroshima (JP)

(21) Appl. No.: 14/271,643

(22) Filed: May 7, 2014

(30) Foreign Application Priority Data
May 8, 2013 (JP) 2013-098774

(51) Int. Cl. H04N 5/235

(52) U.S. Cl. CPC H04N 5/2355
USPC 348/135

(57) ABSTRACT

An image measuring apparatus includes an image capturer capturing an image of a measured object and outputting image data; a memory storing a plurality of first measurement data including the image data; a transmitter transmitting the first measurement data stored in the memory; a controller controlling the image capturer, the memory, and the transmitter; and a position control system controlling a position of the image capturer and outputting second measurement data including focus position data of the image capturer. During position control, the controller capturers an image at a predetermined interval and stores in the memory the first measurement data and the second measurement data so as to be associated with each other. The transmitter transmits the first measurement data stored in the memory depending on a communication status.

### CROSS-REFERENCE TO RELATED APPLICATIONS

The present application claims priority under 35 U.S.C. §119 of Japanese Application No. 2013-098774 filed on May 8, 2013, the disclosure of which is expressly incorporated by reference herein in its entirety.

### BACKGROUND OF THE INVENTION

1. Field of the Invention

The present invention relates to an image measuring apparatus measuring dimensions of a desired portion of an measured object by capturing an image of the measured object. The present invention also relates to an image measuring program.

2. Description of Related Art

Compared to a consumer digital camera and the like, an image measuring apparatus is required to have high-precision performance and is also required to have a high throughput, or high processing performance, depending on a purpose of use. To fulfill such requirements and perform high-speed high-precision measurement, a three-dimensional image measuring apparatus having an autofocus function is generally known (Japanese Patent Laid-Open Publication No. 2001-319219; Japanese Patent Laid-Open Publication No. 2012-168136; and Registered Utility Model No. 3144873).

In contrast autofocus, an image is captured while a focus position of an image capturer, such as a camera, is gradually changed, and then the focus position is determined based on a contrast of the captured image. Such a method is feasible in a simple configuration including only a camera and software, for example. Depending on a communication system connecting a camera and software, however, an uncertain delay in image transfer or frame dropping may occur due to a conflict in communication with other peripheral devices.

### SUMMARY OF THE INVENTION

In view of the conventional circumstances above, the present invention provides an image measuring apparatus achieving contrast autofocus at high precision and high speed.

An aspect of the present invention provides an image measuring apparatus including an image capturer capturing an image of a measured object and outputting image data; a memory storing a plurality of first measurement data including the image data; a transmitter transmitting the first measurement data stored in the memory; a controller controlling the image capturer, the memory, and the transmitter; and a position control system controlling a position of the image capturer and outputting second measurement data including focus position data of the image capturer. When the position control system controls the position of the image capturer, the controller allows the image capturer to capture an image at a predetermined interval and stores in the memory the first measurement data and the second measurement data so as to be associated with each other. The transmitter transmits the first measurement data stored in the memory depending on a communication status.

Specifically, when the obtained image data cannot be transferred due to a conflict in communication with another peripheral device, the image measuring apparatus according to the present invention continues to capture images at a predetermined interval and concurrently retains the image data obtained by the image capturer in the memory. When the communication is restored, the image measuring apparatus can read and transmit the data retained in the memory. This allows appropriate calculation of a focus position.

In another aspect of the present invention, the image measuring apparatus may further include a calculator calculating a focus position of the image capturer from the first measurement data and the second measurement data input from the transmitter through a universal bus. The first measurement data include the image data and a first timestamp; the second measurement data include the focus position data and a second timestamp; and the calculator may compare the first timestamp with the second timestamp to associate the image data with the position data, and calculate the focus position of the image capturer based on the associated image data and position data.

In such an aspect, when a large delay occurs in communication, for example, and image data stored in an address where data not transferred yet is stored is overwritten, the image measuring apparatus can appropriately associate the image data and the position data and appropriately calculate the focus point of the image capturer.

In another aspect of the present invention, the memory can also store the second measurement data together with the first measurement data, and the transmitter can also transmit the first measurement data and the second measurement data associated with each other. Thus, collectively handling the first measurement data and the second measurement data also allows appropriate calculation of the focus point of the image capturer.

Another aspect of the present invention provides an image measuring program for an image measuring apparatus including an image capturer capturing an image of a measured object and outputting image data; a memory storing a plurality of first measurement data including the image data; a transmitter transmitting the first measurement data stored in the memory; and a position control system controlling a position of the image capturer and outputting second measurement data including focus position data of the image capturer. The program allows the position control system to control the position of the image capturer. The program includes allowing the image capturer to capture an image at a predetermined interval and storing in the memory the first measurement data and the second measurement data so as to be associated with each other; allowing a calculator to calculate a focus position of the image capturer from the first measurement data and the second measurement data input from the transmitter through a universal bus, the calculator being connected to the image measuring apparatus that transmits the first measurement data stored in the memory depending on a communication status of the transmitter.

The present invention can provide an image measuring apparatus achieving contrast autofocus at high precision and high speed, and a control program for the same.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an overall view of an image measuring apparatus according to a first embodiment of the present invention;

FIG. 2 is a block diagram illustrating a configuration of a portion of the apparatus;

FIG. 3 is a block diagram illustrating a configuration of a portion of the apparatus;

FIG. 4 is a block diagram illustrating a configuration of a camera in the apparatus;

FIG. 5 is a timing chart illustrating a timestamp of an image and a timestamp of a Z value in the apparatus;

FIG. 6 illustrates a conventional method of autofocus;

FIG. 7 is a timing chart illustrating a conventional method of autofocus;

FIG. 8 is a timing chart illustrating a method of autofocus according to the first embodiment of the present invention;

FIG. 9 is a timing chart illustrating a different mode of the method; and

FIG. 10 is a block diagram illustrating a configuration of a portion of an image measuring apparatus according to a second embodiment of the present invention.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Embodiments of an image measuring apparatus according to the present invention are described in detail below with reference to the attached drawings.

### First Embodiment

### Configuration of Image Measuring Apparatus

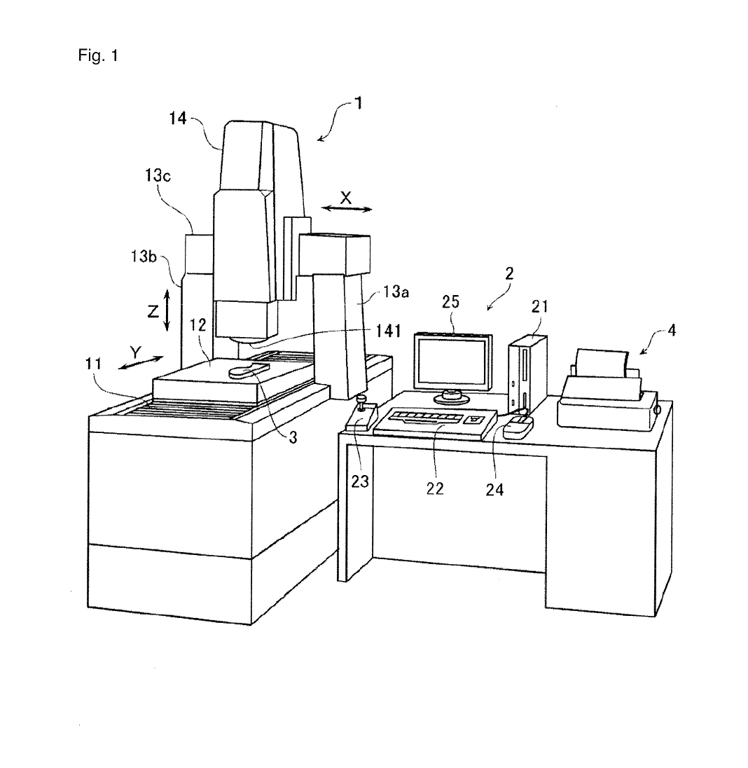

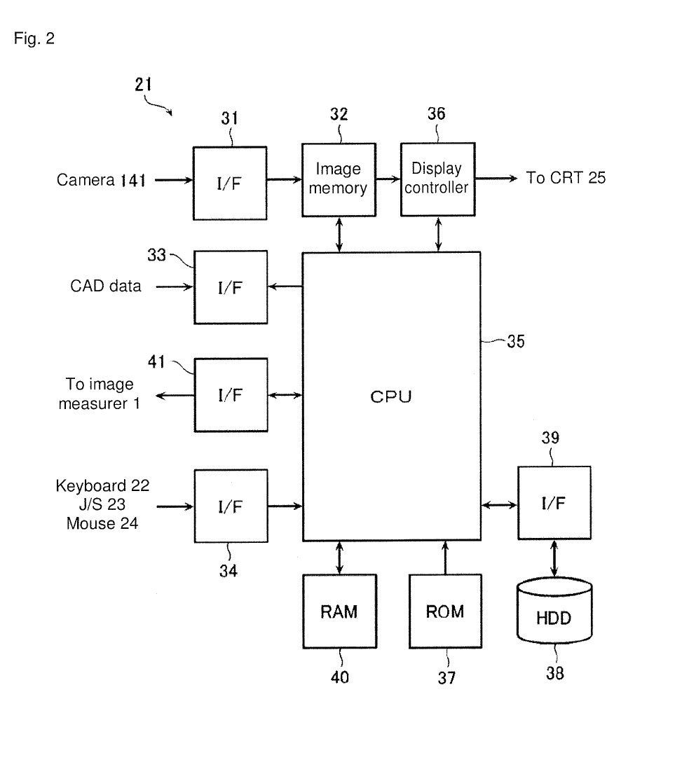

FIG. 1 is an overall view of an image measuring apparatus according to a first embodiment of the present invention. FIGS. 2 to 4 are each a block diagram illustrating a configuration of a portion of the image measuring apparatus. The image measuring apparatus includes a contactless image measurer 1 and a computer system (hereinafter referred to as “PC”) 2 driving and controlling the image measurer 1 and executing required data processing. The image measurer 1 and the PC 2 are connected by a universal bus, such as a USB. The PC 2 has a printer 4 to print out, for example, measurement results and the like.

The image measurer 1 is configured as below. On a mount rack 11, which serves as a sample mover, a movable stage (stage) 12 is placed such that an upper surface thereof as a base surface is aligned with a horizontal plane. A work piece (measured object) 3 is placed on the movable stage 12. The mount rack 11 supports an X-axis guide 13c at upper ends of arm support bodies 13a and 13b standing from two side ends of the mount rack 11.

The movable stage 12 is drivable in a Y-axis direction by a Y-axis drive mechanism provided inside the mount rack 11, for instance. An image capture unit 14 is supported by the X-axis guide 13c so as to be drivable in an X-axis direction by an X-axis drive mechanism.

A camera 141 is mounted to a lower end of the image capture unit 14 so as to be opposite to the movable stage 12.

With reference to FIG. 4, the camera 141 has an image capturer ID, a memory MD, a transmitter SD, and a controller CD. The image capturer ID captures an image of a measured object and outputs image data. The memory MD stores the image data and a timestamp of the image as first measurement data. The transmitter SD transmits the first measurement data stored in the memory. The controller CD controls the image capturer ID, the memory MD, and the transmitter SD. The image capturer ID, the memory MD, the transmitter SD, and the controller CD are connected via a bus BUS to receive and transmit data, commands, and the like.

Various kinds of imaging elements, such as a CCD and CMOS, can be used for the image capturer ID. The memory MD is a buffer memory capable of concurrently storing n pieces of the first measurement data. The memory MD also configures a ring buffer. Specifically, the memory MD sequentially stores the image data and timestamps of images obtained by the image capturer ID. When storing the n+1^{th} first measurement data, the memory MD sequentially overwrites addresses storing old data. The transmitter SD is a USB interface.

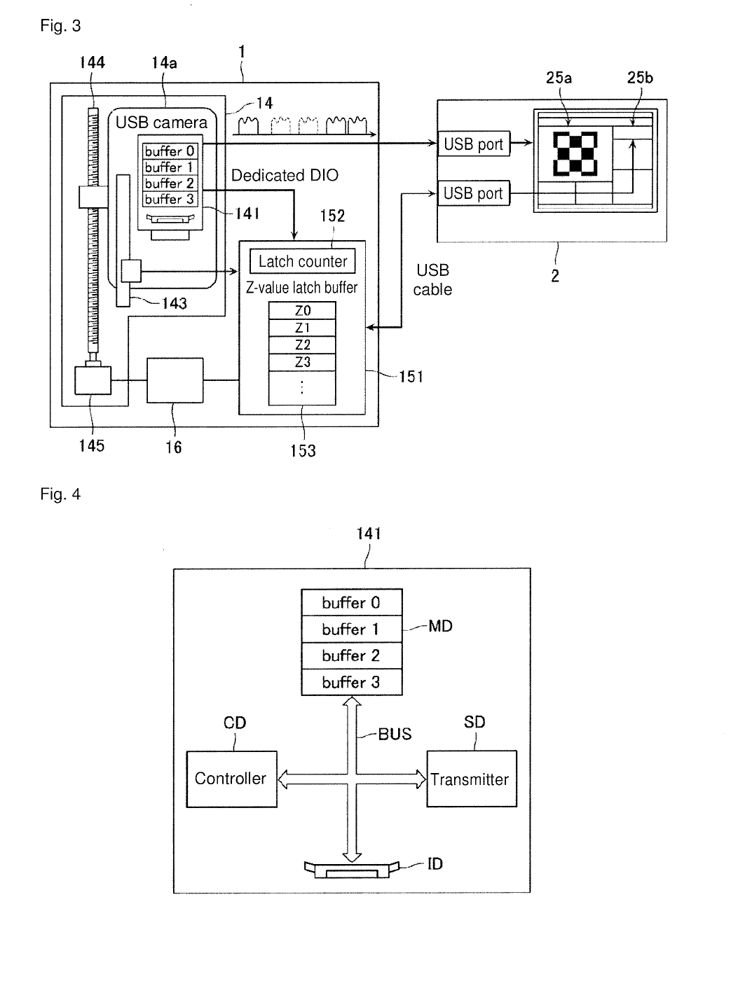

The controller CD can switch a method of controlling the transmitter SD between during measurement of the measured object and during control of a focus position by a position control system. Specifically, during measurement of the measured object, the controller CD retains the image data in the memory and concurrently transmits the image data from the transmitter. More specifically, the camera 141 transmits from the transmitter SD the latest image captured by the image capturer ID during measurement of the measured object. Thus, the image captured by the image capturer ID can be displayed live on a video window 25a (refer to FIG. 3) of a monitor 25 (described later).

Meanwhile, during control of the focus position of the image capturer by the position control system (autofocus), the controller CD allows the image capturer to capture an image at a predetermined interval and stores image data in the memory MD. When the transmitter SD is in communication standby mode, the controller CD retains the image data in the memory MD. When the communication standby mode is released, the controller CD sequentially transmits the retained data from the transmitter SD.

The PC 2 includes a computer main body 21, a keyboard 22 as an input section, a joystick box (hereinafter referred to as “J/S”) 23, a mouse 24, and the monitor 25 as an exemplary display. The computer main body 21 is configured as shown in FIG. 2, for example.

Specifically, in the computer main body 21, the image data of the captured image of the work piece 3 is transferred and input through a USB cable and a USB port (refer to FIG. 3), which serve as a universal digital serial communication line from the camera 141. Then, the image data is stored as a multivalued image in an image memory 32 through an interface (hereinafter referred to as “I/F”) 31.

When offline teaching is performed using CAD data, for example, CAD data of the work piece 3 generated by a CAD system (not shown in the drawings) is input to a CPU 35 through an I/F 33. The CAD data input to the CPU 35 is loaded as image data, such as a bit map, by the CPU 35, for example, and then stored in the image memory 32. The image data stored in the image memory 32 is displayed on the monitor 25 through a display controller 36.

Meanwhile, code data and position data input from the keyboard 22, the J/S 23, and the mouse 24 are input to the CPU 35 through an I/F 34. The CPU 35 executes measurement processing and display processing of measurement results according to various programs, including a macro program stored in a ROM 37 and a measurement program (including an autofocus (AF) control program according to the present invention) and a measurement result display program stored in a RAM 40 from an HDD 38 through an I/F 39.

In addition, the CPU 35 drives and controls the image measurer 1 through an I/F 41 according to the measurement processing above. For example, to display on the video window 25a (refer to FIG. 3) of the monitor 25 an image of the work piece 3 out of a range of image capturing by the camera 141 displayed on the monitor 25, the CPU 35 controls the X- and Y-axis drive mechanisms of the image measurer 1 to relatively move the movable stage 12 or the image capture unit 14, based on input data from the J/S 23 or the mouse 24 according to an operation of an operator.

Then, at a position where the movable stage 12 or the image capture unit 14 is moved, the CPU 35 drives the camera 141 along a Z-axis direction (focus axis direction) using a Z-axis drive mechanism (described later) for autofocus processing and captures the image of the work piece 3 at a focus position. Thereby, the image of the work piece 3 within a new range of image capturing is displayed on the monitor 25. The HDD 38 is a recording medium that stores the various programs, data, and the like. The RAM 40 stores the various programs as well as provides a work area to the CPU 35 for various processing.

In the first embodiment, the image measurer 1 has a controller (not shown in the drawings), which includes a position controller 151 (refer to FIG. 3). The PC 2 controls a focus position of the camera 141 through the position controller 151. In addition, the PC 2 transmits to the camera 141, for example, a signal designating a frame rate or a signal designating intensity of a lighting device (not shown in the drawings).

The camera 141 captures the image of the work piece 3 illuminated by the lighting device at the frame rate designated by the PC 2, and then bulk-transfers the image data of the captured image to the PC 2 through a USB cable or the like as described above. At this time, the position controller 151 similarly transmits the position data of the camera 141 to the PC 2 through a USB cable or a USB port. Various types of lighting can be used as the lighting device, including, for example, a PWM control LED.

The image capture unit 14 has a linear encoder 143, a camera drive mechanism 144, and a Z-axis motor 145. The linear encoder 143 detects and outputs a Z coordinate of the camera 141. The camera drive mechanism 144, which serves as the Z-axis drive mechanism, drives the camera 141 and a measuring head 14a along the Z-axis direction. The Z-axis motor 145 drives the camera drive mechanism 144. The Z-axis motor 145 is connected to the position controller 151 through a power unit 16 provided with the image measurer 1.

The linear encoder 143 is attached such that a scale or the measuring (detection) head 14a moves in the Z-axis direction in conjunction with the camera 141. The position controller 151 measures the Z coordinate of the camera 141 using a counter and outputs a Z value, which is position data. The position controller 151 has a latch counter 152 counting an output number of the Z value and a Z-value latch buffer 153 retaining the obtained Z value as array data. The Z-value latch buffer 153 stores both the obtained Z value and a timestamp of the Z value corresponding to the time when the Z value was obtained.

Specifically, in the position controller 151, the counter (not shown in the drawings) obtains the Z coordinate data of the camera 141 from the linear encoder 143 in response to a trigger signal (described later) and outputs the Z coordinate data; the latch counter 152 counts the output number; and the Z-value latch buffer 153 retains the Z coordinate data as the Z value. The camera 141 is connected to the position controller 151 by a dedicated DIO (digital input/output) cable, which is a dedicated digital communication line.

The position controller 151 outputs a Z-axis drive command to the power unit 16. The power unit 16 supplies drive power to the Z-axis motor 145, which then allows the camera drive mechanism 144 to move the camera 141 in the focus direction. The camera 141 captures the image of the work piece 3 at a desired frame rate as described above and transfers the image data to the PC 2 through a USB cable or the like.

A trigger signal is output from either of the camera 141 or the position controller 151 to the other. In the present embodiment, a camera master system is employed in which a vertical synchronizing (Vsync) signal is output from the camera 141 to the position controller 151 as a trigger signal. In this case, the position controller 151 receives the vertical synchronizing signal, in response to which, the counter obtains a Z coordinate from the linear encoder 143 and outputs the Z coordinate; the latch counter 152 counts an output number; and the Z-value latch buffer 153 retains the Z value.

In accordance with the above, the latch counter 152 is updated; and the Z value retained in the Z-value latch buffer 153 is output to the PC 2 as Z-value array data in response to a read command (request command) from the PC 2, and is then displayed on a counter window 25b (refer to FIG. 3) of the monitor 25. In the first embodiment, the camera 141 is driven along the Z-axis direction. Alternatively, a similar operation can be achieved by controlling an optical system, such as a lens, included in the camera 141. In addition, a USB interface is used as a universal digital serial communication line. Alternatively, another digital serial standard, such as, for example, Gig-E or FireWire, may be used for communication.

In the present embodiment, the camera master system is employed. Alternatively, another system may be employed, including a camera slave system in which the position controller 151 transmits a trigger signal to the camera 141.

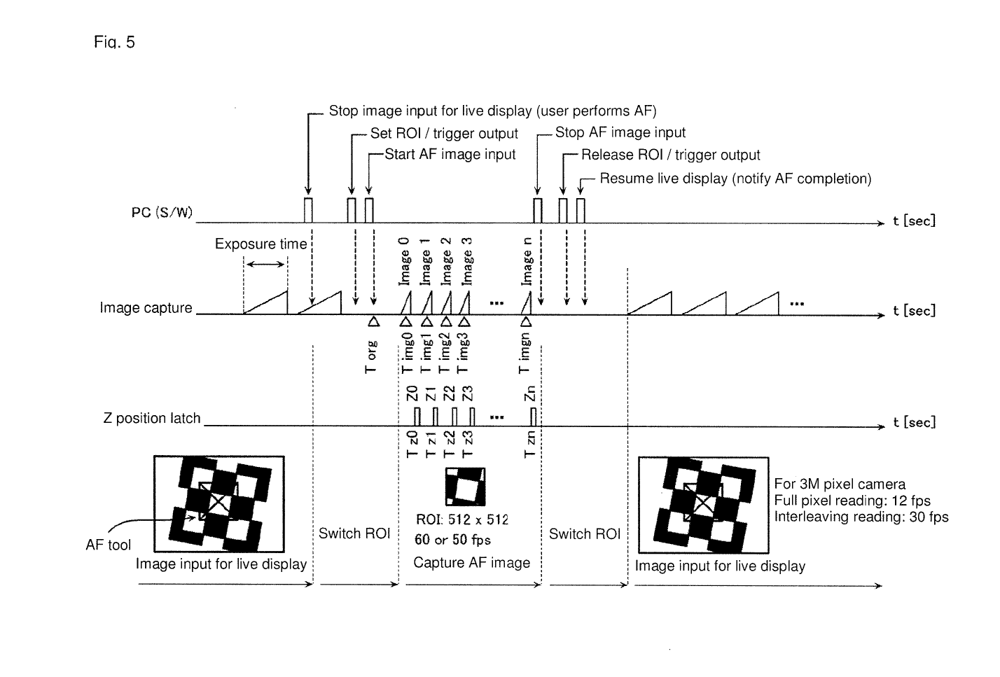

The timestamp of the image above and the timestamp of the Z value are described below with reference to FIG. 5. The timestamp of the image is data pertaining to timing when the image data is obtained and represents a time elapsed from, for example, a start timing of autofocus processing to a timing of obtaining the image data. Meanwhile, the timestamp of the Z value is data pertaining to timing when the Z value is obtained and represents a time elapsed from, for example, a start timing of autofocus processing to a timing of obtaining the Z value. The timestamp of the image above and the timestamp of the Z value are used to calculate a correspondence relationship between the image and the Z value.

In the present embodiment, the timestamp is obtained as below. Specifically, when an autofocus operation is initiated, a command to stop image input for live display is output from the PC 2 to the camera 141 through the USB interface. Subsequently, an image region ROI (Region of Interest) for the autofocus operation and a setting of trigger output (for example, a region of the image region ROI, a frame rate, and the like) are transmitted. Furthermore, a command to start image input for autofocus is output. Accordingly, the image data in the image region ROI is transmitted at a designated frame rate from the camera 141 to the PC 2 through the USB interface. When the image data is output from the camera 141, the latch counter 152 is updated and the Z value is obtained in the Z-value latch buffer.

The timestamp of the k^{th} (k is an integer from 1 to n) image can be expressed as Timgk−Torg, where Timgk represents an image capture timing of the k^{th} image and Torg represents a timing when the command to start image input for autofocus is input to the camera 141. In the present embodiment, the image capture timing Timgk is a timing intermediate between a timing to start exposure of the k^{th} image and a timing to end exposure of the k^{th} image. Furthermore, the timestamp of the k^{th} Z value can be expressed as Tzk−Torg, where Tzk represents a timing of obtaining the k^{th} Z value.

In the present embodiment, the timestamp of the image and the timestamp of the Z value are retained as numerical data that represent the time. In a case, however, where an image capture interval of the camera 141 is a known constant value and a delay time between the image capture timing Timgk and the timing Tzk of obtaining the Z position are known constant values, the timestamp of the image and the timestamp of the Z value may be serial numbers from the start of autofocus. Then, the image capture timing Timgk can be expressed as Timgk=Torg+Tfr×Simg, where Tfr represents the known image capture interval and Simg represents the serial number. Furthermore, the timing Tzk of obtaining the Z value can be expressed as Tzk=Torg+Tfr×Simg+Td, where Td represents the known delay time. In addition, when the timing of capturing the first image is the start point of the autofocus processing time, Torg=0. Then, the image capture timing Timgk can be expressed as Timgk=Tfr×Simg and the timing Tzk of obtaining the Z value can be expressed as Tzk=Tfr×Simg+Td.

The known image capture time Tfr is considered to be set to 60 fps or 50 fps, for example. Furthermore, the delay time between the image capture timing Timgk and the timing Tzk of obtaining the Z position can also be set to a known constant time by calibrating parameters for autofocus.

<Conventional Method of Controlling Focus Position>

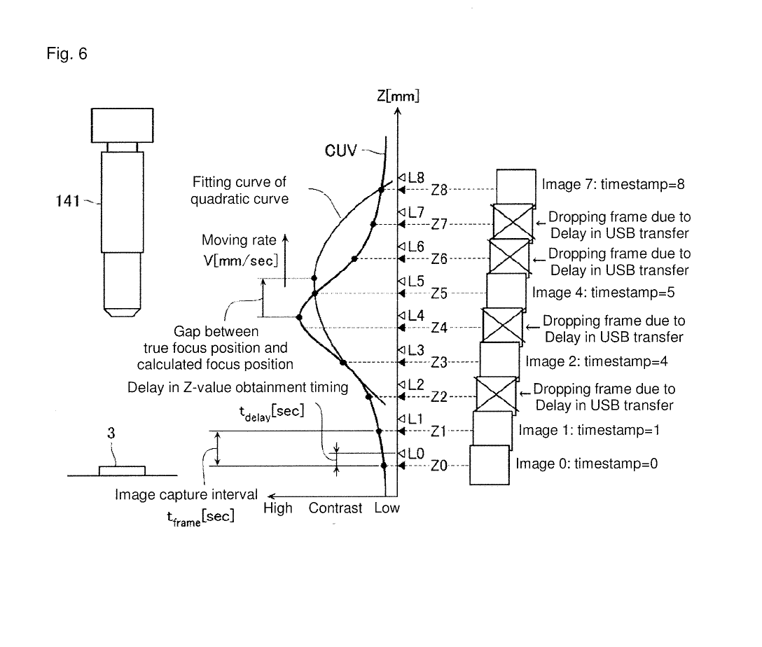

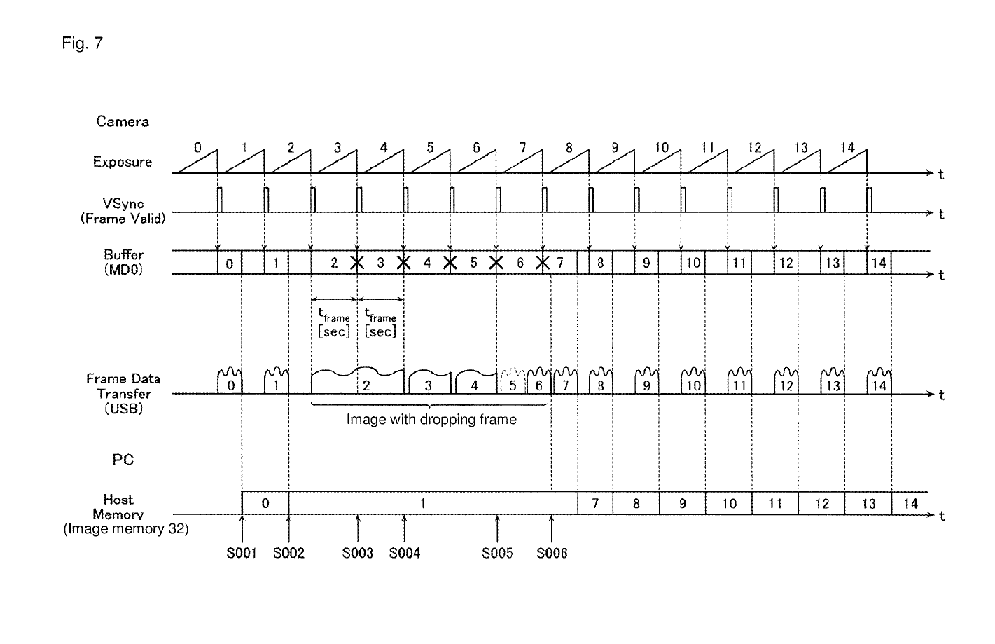

Prior to describing a method of controlling a focus position according to the present embodiment, a conventional method of controlling a focus position is described for comparison purposes. FIGS. 6 and 7 each illustrate the conventional method of controlling the focus position. With reference to FIG. 6, for autofocus processing, the camera 141 is first moved to an autofocus search start position, which is a lower position close to the work piece 3 or an upper position distant from the work piece 3. Then, the camera 141 is moved upward or downward at a moving rate V (mm/sec) to capture images at a plurality of Z coordinates (Z0 to Z8) at constant image capture intervals t_{frame} [sec].

Thereafter, a contrast is calculated from image data at each Z coordinate position, and then a contrast curve CUV is obtained. Among a plurality of calculated contrasts on the obtained contrast curve CUV, a Z coordinate corresponding to a contrast showing the highest numerical value is determined to be a focus position.

With reference to FIG. 7, the camera 141 captures an image and the image capturer ID completes exposure at timing S001. Then, image data obtained by the image capturer ID is retained in a memory MD0. The image data retained in the memory MD0 is transferred to the PC 2 at an appropriate timing by the transmitter SD and the USB cable. The image data in the memory MD0 is deleted at timing 5002, when the image transfer is complete. The transferred image data is latched in the image memory 32 of the PC 2. Due to a time lag t_{delay} [sec] from the completion of exposure by the camera 141 to obtainment of a Z value of the camera 141 after a vertical synchronizing signal is output, a Z position at a timing when the image data is captured is calculated from an expression below, where L1 is data of a Z position which is obtained first and latched.

$${Z}_{k} = \frac{\{ {L}_{I + 1} \cdot {t}_{delay} - {L}_{I} \cdot ( {t}_{frame} - {t}_{delay} ) \}}{{t}_{frame}} \qquad [ Expression 1 ]$$

In a case where an uncertain delay occurs in the image transfer due to a conflict in communication with another peripheral device, for example, in a USB cable and the transfer time of the k^{th} image exceeds t_{frame} [sec], the k+1^{th} image data is transferred from the image capturer ID to the memory MD0 before the transfer of the k^{th} image is complete, and thus the data in the memory MD0 is overwritten (timing S003). Furthermore, in a case where the transfer of the k^{th} image is not complete even after t_{frame} [sec] from overwriting of the data, the data in the memory MD0 is further overwritten with the k+2^{th} image (timing S004). Thus, the transfer of the k^{th} image from the transmitter SD is forcibly interrupted and the transfer of the k+1^{th} image starts. Although incomplete image data is transmitted to the PC 2, such incomplete image data is excluded from the contrast calculation. Hereinafter, an event where the image data is excluded from the contrast calculation is referred to as “frame dropping.” Once frame dropping occurs, even after a communication rate of the USB cable or the like is restored, there may be a case where the transfer cannot be performed since the image to be transferred has been deleted from the memory MD0 (timing S005) or a case where the time allowed for the image data transfer is shortened and thus frame dropping occurs yet again (timing S006).

With many dropping frames in the image, a Z position different from an actual focus position may be determined to be a focus position by fitting, as shown in FIG. 6.

<Method of Controlling Focus Position According to the Present Embodiment>

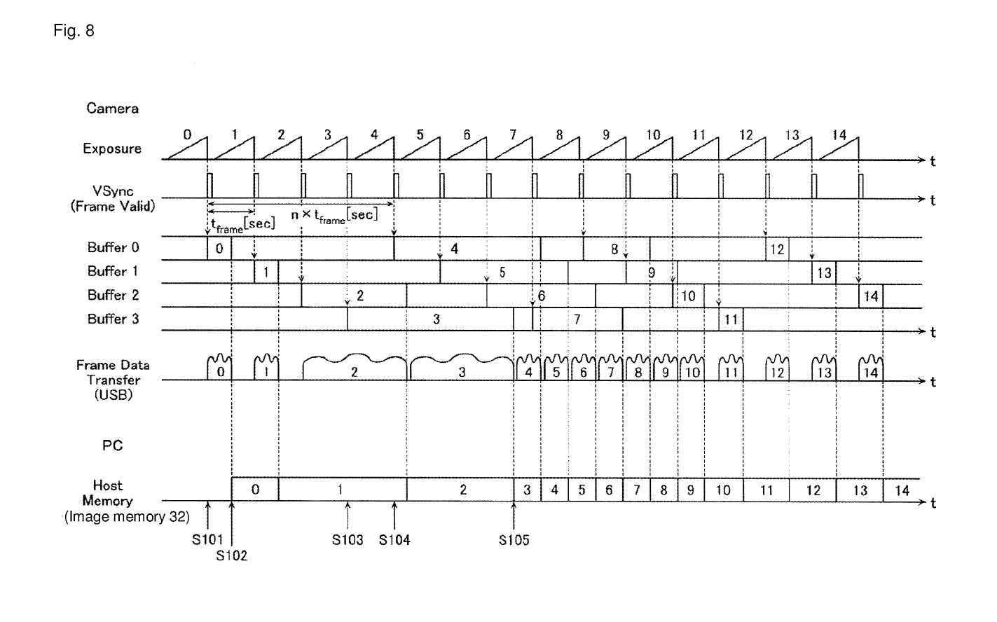

A method of controlling a focus position according to the present embodiment is described below. FIG. 8 illustrates the method of controlling the focus position according to the present embodiment. The memory MD according to the present embodiment can retain a plurality of image data simultaneously. For an autofocus operation, the controller CD allows the image capturer ID to capture images at predetermined intervals (t_{frame} [sec]) and concurrently stores image data in the memory MD.

In a method of measuring an image according to the present embodiment, at timing S101, when the camera 141 completes exposure, image data obtained by the image capturer ID is retained in a buffer 0 of the memory MD. The image data retained in the buffer 0 of the memory MD is transferred to the PC 2 at an appropriate timing by the transmitter SD and the USB cable. The image data in the buffer 0 of the memory MD is deleted at timing S102, when the image transfer is complete. The transferred image data is latched in the image memory 32 of the PC 2.

In a case where a communication delay occurs and a retention time of the k^{th} data exceeds t_{frame} [sec] at timing 5103, the k+1^{th} data can be latched in another buffer (buffer 3) of the memory MD in the present embodiment, and thus no data is overwritten. In addition, even in a case where t_{frame} [sec] further elapses at timing S104, the k+2^{th} data can be retained in yet another buffer (buffer 4). Thus, no data is overwritten and the transmission of the k^{th} data from the transmitter SD is not interrupted. Accordingly, in the case where the obtained image data cannot be transferred due to a conflict in communication or the like, the data are sequentially retained in the memory MD. Furthermore, when a commination status is restored at timing S105, image capturing continues at the predetermined intervals (t_{frame} [sec]) and concurrently the image data retained in the plurality of buffers can be sequentially transmitted from the transmitter SD.

To prevent frame dropping in the conventional method of controlling the focus position, it is necessary to complete image data transfer at t_{frame} [sec] or less from obtainment of the image data. In contrast, in the present embodiment, when the number of frames of the image data that can be retained in the memory MD is n, a maximum of approximately n×t_{frame} [sec] image data can be retained from obtainment of the image data. Thus, in the image measurement apparatus according to the present embodiment, the image data can be obtained appropriately regardless of a status of communication with the PC 2. Accordingly, the focus position can be calculated appropriately, even when a conflict occurs in communication with another device for digital communication connected to the image measuring apparatus or computer, or when a delay in communication occurs since a multi-CPU is installed in the computer or the computer operates on a multi-task OS.

FIG. 8 illustrates a mode in which four images can be simultaneously stored in the memory MD (n=4) for explanation purposes. In a case, however, where the capacity of the memory MD is 32 MB and the size of the image data is 256×256, for example, 512 images can be simultaneously stored in the memory MD (n=512).

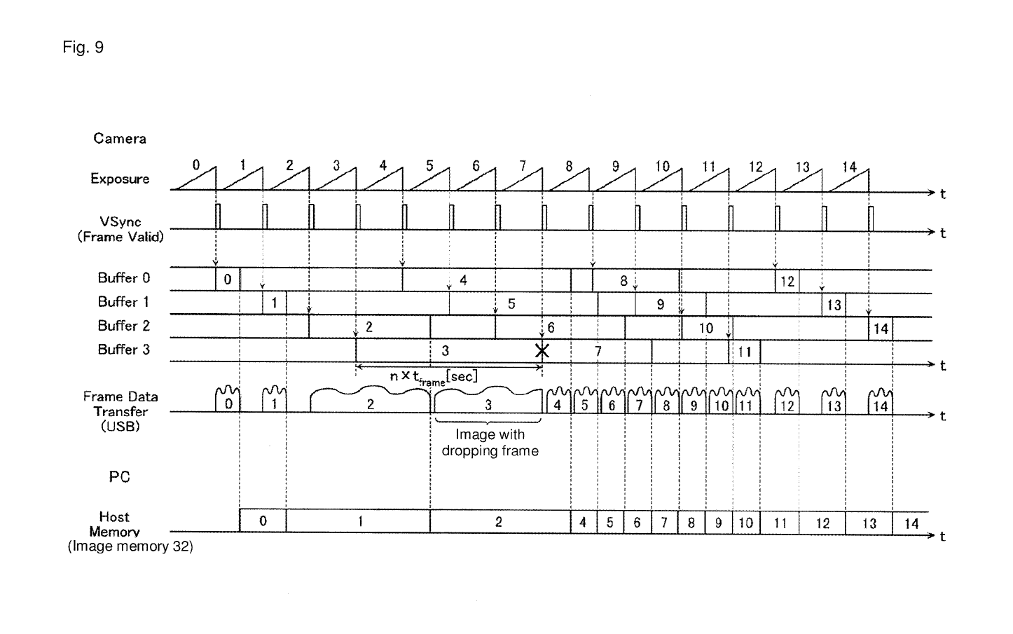

Furthermore, in the present embodiment, the timestamp of the image is retained together with the image data as the first measurement data, and the timestamp of the Z value is retained together with the Z value as the second measurement data. Thus, even when a delay in communication occurs beyond a duration of n×t_{frame} [sec], as shown in FIG. 9, an appropriate correspondence relationship between the image data and the Z value can be obtained, and thus the focus position can be calculated appropriately.

### Second Embodiment

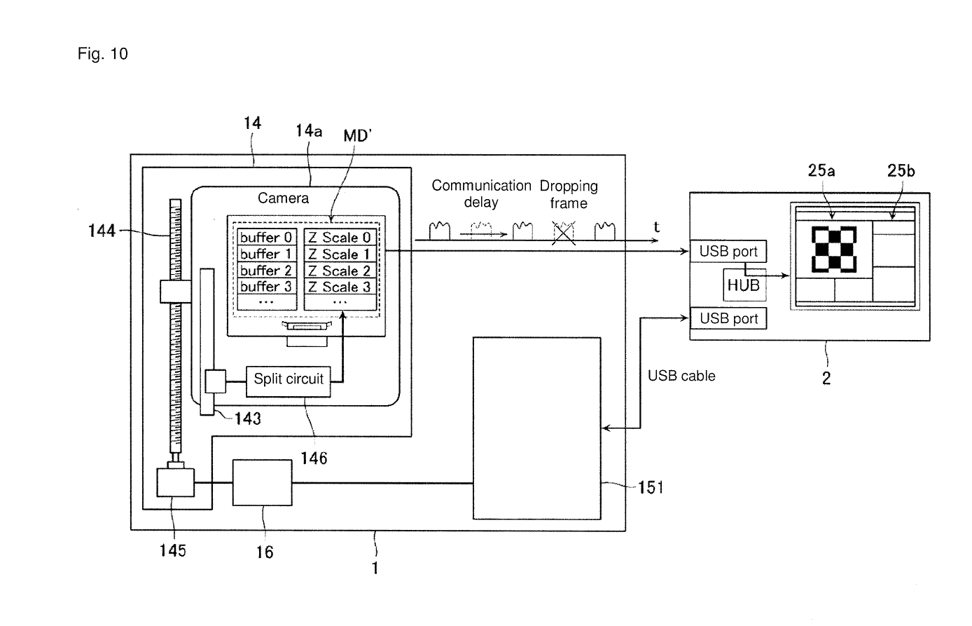

An image measuring apparatus according to a second embodiment of the present invention is described below. FIG. 10 is a block diagram illustrating a configuration of a portion of the image measuring apparatus according to the present embodiment. The image measuring apparatus of the present embodiment is configured basically similar to the image measuring apparatus of the first embodiment. However, the image measuring apparatus of the present embodiment is different in that image data and Z value data are both stored in a memory MD′. The image capture unit 14 of the present embodiment has a split circuit 146 to store a Z value in the memory MD′. The image measuring apparatus of the present embodiment operates in a similar manner to the image measuring apparatus of the first embodiment during control of a focus position. However, in the image measuring apparatus of the present embodiment, the image data and Z value are stored in the memory MD′ and are transmitted to the PC 2 through a USB cable. Thus, even when frame dropping occurs, it is unnecessary to match the image data and Z value separately, thus allowing efficient calculation.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

The present invention is not limited to the above-described embodiments, and various variations and modifications may be possible without departing from the scope of the present invention.

What is claimed is:

1. An image measuring apparatus comprising:
an image capturer configured to capture an image of a measured object and outputting image data;
a memory configured to store a plurality of first measurement data including the image data;
a transmitter configured to transmit the first measurement data stored in the memory;
a controller configured to control the image capturer, the memory, and the transmitter; and
a position controller configured to control a position of the image capturer and output second measurement data including focus position data of the image capturer, wherein:
when the position controller controls the position of the image capturer, the controller allows the image capturer to capture an image at a predetermined interval and stores in the memory the first measurement data and the second measurement data so as to be associated with each other, and
the transmitter transmits the first measurement data stored in the memory depending on a communication status.

2. The image measuring apparatus according to claim 1, further comprising:
a calculator configured to calculate a focus position of the image capturer from the first measurement data and the second measurement data input from the transmitter through a universal bus, wherein:
the first measurement data include the image data and a first timestamp,
the second measurement data include the focus position data and a second timestamp, and
the calculator is configured to compare the first timestamp with the second timestamp to associate the image data with the focus position data, and is further configured to calculate the focus position of the image capturer based on the associated image data and focus position data.

3. The image measuring apparatus according to claim 1, further comprising:
a calculator configured to calculate a focus position of the image capturer from the first measurement data and the second measurement data input from the transmitter through a universal bus, wherein:
the memory is further configured to store the second measurement data together with the first measurement data,
the transmitter is configured to transmit the first measurement data and the second measurement data associated with each other, and
the calculator is configured to calculate the focus position of the image capturer based on the associated image data and focus position data.

4. A non-transitory computer-readable medium for an image measuring apparatus, the image measuring apparatus having an image capturer capturing an image of a measured object and outputting image data, a memory storing a plurality of first measurement data including the image data, a transmitter transmitting the first measurement data stored in the memory, and a position controller controlling a position of the image capturer and outputting second measurement data including focus position data of the image capturer, the computer readable medium instructing the position controller to control the position of the image capturer,
the computer-readable medium including an executable set of instructions which, when executed by a processor, causes the processor to execute operations comprising:
instructing the image capturer to capture an image at a predetermined interval and storing in the memory the first measurement data and the second measurement data so as to be associated with each other; and
instructing a calculator to calculate a focus position of the image capturer from the first measurement data and the second measurement data input from the transmitter through a universal bus, the calculator connected to the image measuring apparatus which transmits the first measurement data stored in the memory depending on a communication status of the transmitter.
